(19) United States
(12) Patent Application Publication
(10) Pub. No.: US 2025/0183965 A1
(43) Pub. Date: Jun. 5, 2025

(54) MULTI-LAYER RECEPTION BASED ON DOWNLINK CHANNEL ESTIMATIONS

(71) Applicant: Apple Inc., Cupertino, CA (US)

(72) Inventors: Haitong Sun, Saratoga, CA (US); Ankit Bhamri, Haar Bavaria-Bayern (DE); Hong He, San Jose, CA (US); Dawei Zhang, Saratoga, CA (US); Wei Zeng, Saratoga, CA (US); Huaning Niu, San Jose, CA (US); Chunhai Yao, Beijing (CN)

(73) Assignee: Apple Inc., Cupertino, CA (US)

(21) Appl. No.: 18/925,600

(22) Filed: Oct. 24, 2024

Related U.S. Application Data
(60) Provisional application No. 63/604,849, filed on Nov. 30, 2023.

(51) Int. Cl. H04B 7/06; H04W 24/10; H04W 72/23

(52) U.S. Cl. CPC H04B 7/0626; H04W 24/10; H04W 72/23

(57) ABSTRACT

The present application relates to a reduced complexity UE. In an example, the UE includes multiple receive ports to support downlink multiple input multiple output (MIMO) operations. This set can be six or more to support six or more layers for the downlink MIMO operations. A first set of the receive ports are logically grouped in a first group, and a second set of the receive ports are logically grouped in a second group. A channel state information (CSI) sent by the UE to a base station can indicate the mapping of the layers (or the receive ports) to codewords that the base station is to send to the UE. Additionally, or alternatively, an SRS transmission by the UE is associated with a particular group of the receive ports.

### CROSS-REFERENCES TO OTHER APPLICATIONS

This application claims priority to U.S. Provisional Application No. 63/604,849, for “MULTI-LAYER RECEPTION BASED ON DOWNLINK CHANNEL ESTIMATIONS” filed on Nov. 30, 2023, which are herein incorporated by reference in its entirety for all purposes.

### BACKGROUND

Fifth generation mobile network (5G) is a wireless standard that aims to improve upon data transmission speed, reliability, availability, and more. This standard, while still developing, includes numerous details related to, for instance, a user equipment (UE) communicating with a transmission and reception point (TRP) of a network to send and receive data. In an example, multiple input multiple output (MIMO) communications are used.

### BRIEF DESCRIPTION OF THE DRAWINGS

FIG. 1 illustrates an example of a network environment, in accordance with some embodiments.

FIG. 2 illustrates an example of a multi-layer reception in a reduced complexity user equipment (UE), in accordance with some embodiments.

FIG. 3 illustrates an example of channel state information (CSI) reporting that indicates a codeword-to-layer mapping, in accordance with some embodiments.

FIG. 4 illustrates an example of a sequence diagram between a UE and a base station in support of CSI reporting indicating a codeword-to-layer mapping, in accordance with some embodiments.

FIG. 5 illustrates an example of grouping of sounding reference signal (SRS) elements and transmit chains in support of SRS transmissions for downlink channel estimations associated with receive chain groups, in accordance with some embodiments.

FIG. 6 illustrates an example of a sequence diagram between a UE and a base station in support of SRS transmissions for downlink channel estimations associated with receive chain groups, in accordance with some embodiments.

FIG. 7 illustrates an example of an operational flow/algorithmic structure for a reduced complexity UE to support downlink channel estimations, in accordance with some embodiments.

FIG. 8 illustrates an example of an operational flow/algorithmic structure for a base station to support downlink channel estimations for communications with a reduced complexity UE, in accordance with some embodiments.

FIG. 9 illustrates an example of receive components, in accordance with some embodiments.

FIG. 10 illustrates an example of a UE, in accordance with some embodiments.

FIG. 11 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) can communicate with a network, such as with a base station of the network. To improve data throughput, a multiple input multiple output (MIMO) implementation can be used, where the UE can include multiple transmit and/or receive chains. When multiple receive chains (also referred to as reception chains or Rx chains) are implemented, downlink MIMO can be supported. Particularly, multiple downlink channels can be used to simultaneously send data to the UE, whereby these channels correspond to the different receive chains. However, the qualities of downlink channels need to be estimated prior to such transmissions such that to apply proper coding to the data. One approach involves the UE estimating the qualities by at least performing measurements on channel state information reference signals (CSI-RS) sent on such channels and sending a channel state information (CSI) report indicating information related to the measurements (such as a UE selected or preferred precoder) to the base station. Another approach involves the base station estimating the qualities, whereby the UE sends sounding reference signals (SRS) and the base stations performs measurements on such signals. The former approach may be more suitable when reciprocity between the uplink and downlink channels is less likely. In comparison, the second approach may be more suitable when the reciprocity is likely.

In both cases, the UE may support a large number of RF chains (e.g., six or eight). This large number creates a complexity challenge related to at least the processing and/or the overhead associated with determining the downlink channel qualities. To deal with such challenges, a reduced complexity can be implemented for the UE (in which case the UE may be referred to as a reduced complexity UE). In particular, the RF channels can be grouped together (e.g., logically) such that the CSI-RS or the SRS is processed based on the grouping (e.g., the logical grouping) rather than the individual receive chains, thereby reducing the overall complexity.

Embodiments of the present disclosure describes different techniques for configuring a reduced complexity UE such that to enable downlink channel estimations in support of downlink MIMO for physical downlink shared channel (PDSCH) reception. In one example related to CSI reporting, the UE can report a mapping of codewords to layers, where each layer corresponds to one of the receive chains. For example, the UE can include in its CSI report that a first codeword (e.g., “CW 0”) is mapped to the first four layers (e.g., “layers 0, 1, 2, and 3”) and a second codeword (e.g., “CW 1”) is mapped to the second four layers (e.g., “layers 4, 5, 6, and 7”) when the UE supports eight layers. In one example related to SRS, the UE can determine the number “x” of transmit ports to send an SRS resource and the number of “y” receive ports to receive downlink data. Based on the two numbers, the UE can determine a mapping of SRS resources to its receive ports. Similarly, the base station can determine this mapping. According, when the SRS resource is sent, the UE and the base station can associate that subsequent data received on this subset with a channel estimation determined from the SRS transmission. These and other features are further described herein below.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or digital signal processors (DSPs) that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “TRP” as used herein refers to a device with radio communication capabilities that is a network node of a communications network (or, more briefly, network) and that may be configured as an access node in the communications network. A UE's access to the communications network may be managed at least in part by the TRP, whereby the UE connects with TRP to access the communications network. Depending on the radio access technology (RAT), the TRP can have a number of transmit and receive antenna elements generating directional beams.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during execution of program code.

The term “connected” may mean that two or more elements at a common communication protocol layer have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

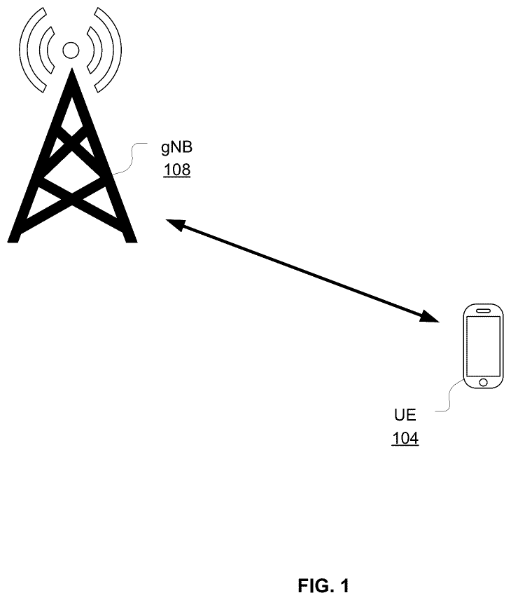

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards. As further described in the next figures, the gNB 108 can be deployed as a TRP in a cell that includes multiple TRPs.

The gNB 108 may transmit information (for example, data and control signaling) in the downlink direction by mapping logical channels on the transport channels and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in an SSB. The SSBs may be used by the UE 104 during a cell search procedure (including cell selection and reselection) and for beam selection.

The PDSCH may be used to transfer end-user application data, signaling radio bearer (SRB) messages, system information messages (other than, for example, MIB), and SIs.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include a channel status information reference signal (CSI-RS). The CSI-RS may be a multi-purpose downlink transmission signal that may be used for CSI reporting, beam management, connected mode mobility, radio link failure detection, beam failure detection and recovery, and fine-tuning of time and frequency synchronization. Similarly, the UE can transmit reference signals to the gNB 108 for measurements to be performed by the gNB 108 (e.g., in use cases where reciprocity is not assumed between a downlink channel and an uplink channel). These reference signals can include, for example, a sounding reference signal (SRS).

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data) and can carry UCI.

The UE 104 and the gNB 108 may perform beam management operations to identify and maintain desired beams for transmission in the uplink and downlink directions. The beam management may be applied to both PDSCH and PDCCH in the downlink direction and PUSCH and PUCCH in the uplink direction.

In an example, communications with the gNB 108 and/or the base station can use channels in the frequency range 1 (FR1), frequency range 2 (FR2), and/or a higher frequency range (FRH). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

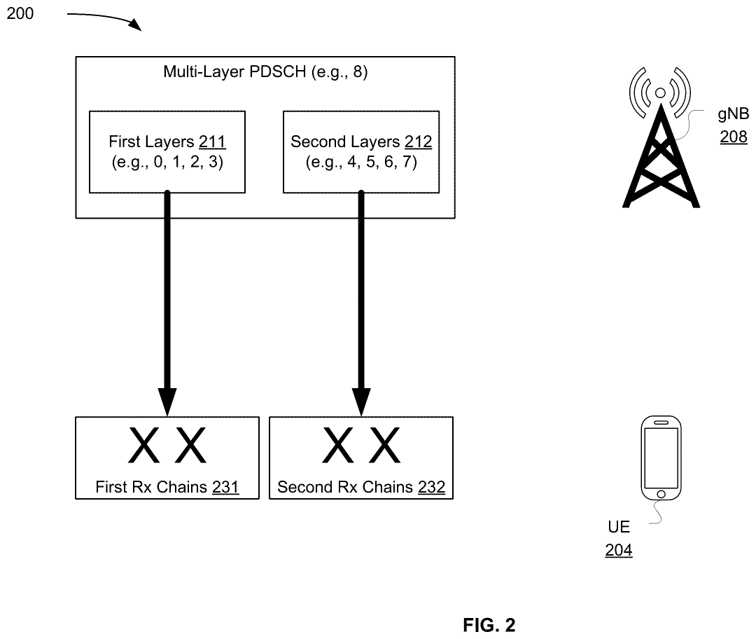

FIG. 2 illustrates an example 200 of a multi-layer reception in a reduced complexity UE, in accordance with some embodiments. As illustrated, a gNB 208 (which is an example of the gNB 108 of FIG. 1) and a UE 204 (which is an example of the UE 104 of FIG. 1) are in communication using MIMO operations. On the downlink, the UE 204 can include multiple receive chains, such that multiple layers of PDSCH can be received simultaneously. The UE 204 can be a reduced complexity UE, whereby the receive chains (or at least the receive antennas) are logically grouped. As further described herein below, signals received by a same group of receive chains are associated with a same codeword and/or correspond to downlink channels for which the channel estimation from SRS resource(s) are associated with the same group.

For illustrative purposes, FIG. 2 shows eight receive chains (each pair of receive antennas is shown with an “X”), grouped in two groups: first receive chains 231 (a logical group of four receive chains) and second receive chains 232 (another logical group of four receive chains). Nonetheless, the embodiments are not limited as such. Instead, a different number of receive chains is possible (e.g., six receive chains) and/or a different number of groups is possible.

When the gNB 208 sends downlink information to the UE 204, this information is coded into codewords. The number of codewords can depend, among other factors, on the number of layers. A codeword can be subject to scrambling, modulation, layer mapping, precoding, resource element mapping, and OFDM signal mapping before being sent by the gNB 208. The layer mapping may map the codeword to specific layers of PDSCH. Each layer can be associated with a specific precoder. In the case of no reciprocity between an uplink and a downlink channel (e.g., such as in the case of frequency division duplexing (FDD), the precoder can be indicated by the UE 204 in a CSI report. In the case of reciprocity between an uplink and a downlink channel (e.g., such as in the case of time division duplexing (TDD), the gNB 208 can determine the precoder based on uplink SRS transmissions by the UE 204.

More particularly, different modes exist to support downlink MIMO operations. A first mode does not use downlink and uplink channel reciprocity (e.g., FDD frequency bands). Here, the UE 204 measures CSI based on CSI-RS with multiple ports transmitted from the gNB 208 and reports the CSI. The CSI contains PMI (Precoding Matrix Indicator), RI (Rank Indicator), CQI (Channel Quality Indicator), CRI (CSI-RS Resource Indicator), LI (Layer Indicator), etc. Different types of CSI codebook also exist. Type I codebook represents a low resolution CSI feedback but supports up to eight layers for example. Type II codebook represents high resolution CSI feedback buts support only up to 4 layers.

A second mode uses downlink and uplink channel reciprocity (e.g., TDD frequency bands). Here, the gNB 208 configures the UE 204 to transmit SRS with antenna switching, which is configured with SRS-ResourceSet with usage set to “antennaSwitching.” The gNB 208 estimates an uplink channel from antenna switching SRS transmitted from the UE 208 and acquire downlink channel information based on the downlink and uplink channel reciprocity. The gNB 208 can determine the downlink precoder or uses downlink port selection codebook to refine the downlink precoder.

The layers for simultaneous PDSCH transmissions can be grouped (e.g., logically). Referring back to the illustrative use case of eight layers, FIG. 2 shows two groups: first layers 211 (a logical group of layers “0,” “1,” “2,” and “3”) and second layers 212 (a logical group of layers “4,” “5,” “6,” and “7”). Of course, a different grouping of the eight layers is possible and/or a different number of layers and/or groups is possible. A first codeword is mapped to the first layers 211, whereas a second codeword is mapped to the second layers 212. The first layers 211 can be associated with the first receive chains 231, whereas the second layers 212 can be associated with the second receive chains 232. As such, the first receive chains 231 are used to receive the first codeword, whereas the second receive chains 232 are used to receive the second codeword.

Accordingly, up to eight layer PDSCH (more than four layers) is transmitted with two codewords (CW). The UE 204 with six or eight receive antenna can have its receive antenna distributed into two groups, each group can be used to receive one CW. When the gNB 208 transmits eight layer PDSCH, each CW contains four layers. At the UE 204, each group of four receive antennas can be used to handle one of the CWs.

In the above example of four layers grouped in two layer groups, eight receive antennas also grouped in two antenna groups, and two codewords, the first codeword is associated with a first layer group and a first antenna group (e.g., the first layers 211 and the first receive chains 231) and the second codeword is associated with a second layer group and a second antenna group (e.g., the second layers 212 and the second receive chains 232). The first codeword is sent using four downlink channels between the gNB 208 and the UE 204. Similarly, the second codeword is sent using four other downlink channels between the gNB 208 and the UE 204.

Channel estimation per downlink channel (or a set of four downlink channels) is needed to determine the precoding to be used for each of the two codewords. As explained herein above, either the UE 204 can determine the precoding and indicates so to the gNB 208 based on CSI reference signals, or the gNB 208 determines the precoding based on SRS transmissions from the UE 204. In both cases, the UE 204 and the gNB 208 can exchange information about logical groupings to enable the channel estimations. For example, in the case of CSI reporting (or the no reciprocity use case), the UE 204 can indicate a codeword-to-layer mapping (or, equivalently, layer-to-codeword mapping) to the gNB 208, so that the relevant precoding is applied to a codeword. In the case of SRS transmission(s) on an uplink channel (or the reciprocity use case), downlink channels are reciprocal to the uplink channel. A group of receive antennas receive a codeword sent on these downlink channels. The precoding relevant to these downlink channels is applied to the codeword. The grouping needs to be determined such that the codeword can be properly processed.

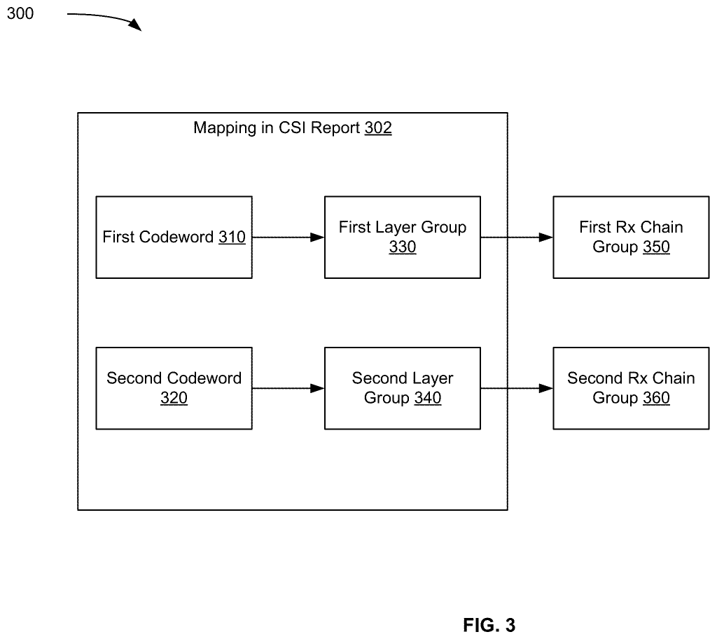

FIG. 3 illustrates an example 300 of CSI reporting that indicates a codeword-to-layer mapping, in accordance with some embodiments. A UE (e.g., the UE 204 of FIG. 2) includes multiple receive chains (or at least multiple receive antennas) that are grouped in a first receive chain group 350 (or at least a first receive antenna group) and a second receive chain group 360 (or at least a second receive antenna group). The UE can indicate to a base station (e.g., the gNB 208 of FIG. 2) a codeword-to-layer mapping (or equivalently, a layer-to-codeword mapping). This mapping can be indicated in a CSI report 302 sent to the base station. In an example, the mapping indicates the layers, at the UE side, associated with a same codeword to be sent by a base station. These layers correspond to groups of receive chains (or the groups of receive antennas). The base station can then process the codeword before its transmission to the UE by using precoding information associated with these layers.

In the illustration of FIG. 3, the mapping indicates that a first codeword 310 (e.g., CW “0”) is associated with a first layer group 330. The mapping also indicates that a second codeword 320 (e.g., CW “1”) is associated with a second layer group 340. The first layer group 330 can include multiple layers, whereas the second layer group 340 can include multiple layers. The first layer group 330 is associated with the first receive chain group 350 (or the first receive antenna group) that includes multiple receive chains (or at least one receive antenna). The second layer group 340 is associated with the second receive chain group 360 (or the second receive antenna group) that includes multiple receive chains.

Referring back to the example of eight layers, each receive group 350 and 360 includes four receive antennas. The first layer group 330 includes layers “0,” “1,” 2,” and “3.” The second layer group 340 includes layers “4,” “5,” 6,” and “7.” The first codeword 310 corresponds to any codeword to be sent by the base station and that are indexed with index “0” (e.g., CW “0”). The second codeword 310 corresponds to any codeword to be sent by the base station and that are indexed with index “1” (e.g., CW “1”). As such, the mapping in the CSI report 302 indicates that a CW “0” is associated with layers “0,” “1,” 2,” and “3,” whereas a CW “1” is associated with layers “4,” “5,” 6,” and “7.” When processing a CW “0” to be sent to the UE, the base station applies the precoding information related to layers 0,” “1,” 2,” and “3.” When processing a CW “1” to be sent to the UE, the base station applies the precoding information related to layers “4,” “5,” 6,” and “7.”

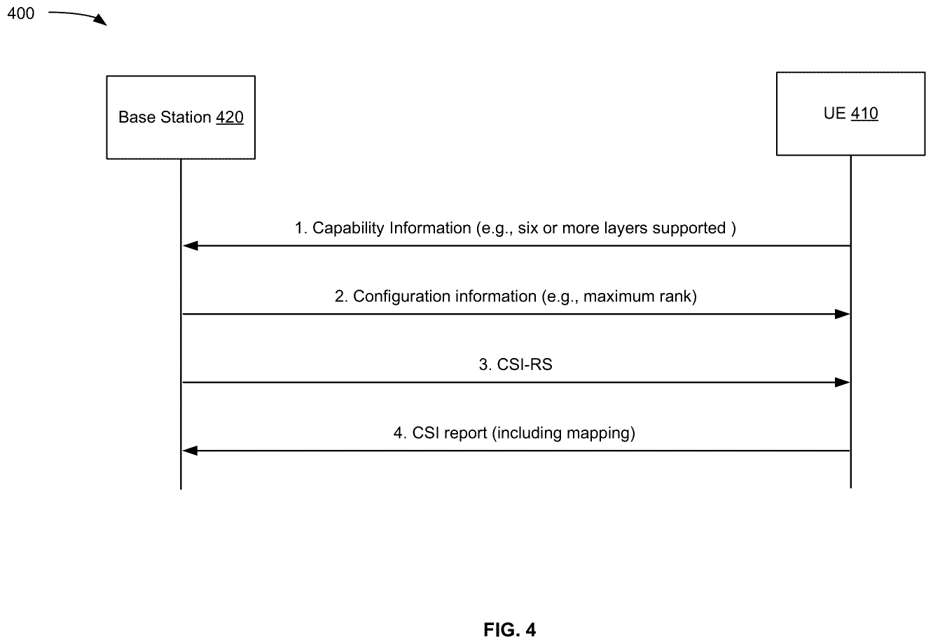

FIG. 4 illustrates an example 400 of a sequence diagram between a UE 410 (an example of the UE 204 of FIG. 2) and a base station 420 (an example of the gNB 208 of FIG. 2) in support of CSI reporting indicating a codeword-to-layer mapping, in accordance with some embodiments. As illustrated, the UE 410 sends capability information to the base station 420 (e.g., via radio resource control (RRC) signaling). The capability information reports the maximum number of layers for PDSCH reception that the UE 410 supports. In an example, this number is more than four (e.g., six, eight, or a different positive integer greater than four). In an example, the UE 410 reports the maximum number of spatial multiplexing layer(s) supported by the UE 410 for downlink reception by using RRC signaling that includes a maxNumberMIMO-LayersPDSCH information element (IE). The maxNumberMIMO-LayersPDSCH indicates the maximum number as a value and is reported by the UE 410 per feature set per component-carrier (FSPC), for example, per component carrier per band per band combination (BC). The candidate values for MIMO-LayersDL can be six or eight (e.g., is extended to include “sixLayers”). An example is as follows:

```
MIMO-LayersDL ::= ENUMERATED {twoLayers, fourLayers, sixLayers, eightLayers}
FeatureSetDownlinkPerCC ::=  SEQUENCE {
  supportedSubcarrierSpacingDL SubcarrierSpacing,
  supportedBandwidthDL SupportedBandwidth,
  channelBW-90mhz ENUMERATED {supported}
  maxNumberMIMO-LayersPDSCH MIMO-LayersDL
  supportedModulationOrderDL ModulationOrder
}
```

Next, the base station 420 sends configuration information to the UE 410 based on the capability information. The configuration information can configure the UE 410 to use a certain number of layers (e.g., up to the maximum number that it supports) for PDSCH reception. The configuration information can indicate a maximum rank (e.g., the maximum number of layers) that the UE 410 needs to report. This maximum rank can be denoted as D_{maxRank}. Different options can exist to indicate D_{maxRank} to the UE 410. In one example, D_{maxRank} is indicated in a restriction configuration (e.g., in CodebookConfig). The rank restriction is a bitmap. D_{maxRank} can be the maximum rank that has the corresponding bit configured as “1.” For instance, the bitmap can include bits, each bit corresponding to a rank (e.g., the first bit corresponding to a rank of one, the second bit corresponding to a rank of two, and so on). One or multiple bits can be set to “1”. Among all the bits that are set to “1”, the bit corresponds to the largest number of layers determines the maximum rank. For Type I Single Panel codebook, D_{maxRank} is configured as typeI-SinglePanel-ri-Restriction. For Type I Multi Panel codebook, D_{maxRank} is configured as ri-Restriction. For Type II regular codebook, D_{maxRank} is configured as typeII-RI-Restriction. For Type II port selection codebook, D_{maxRank} is configured as typeII-PortSelectionRI-Restriction. In a second example, the maximum rank (e.g., D_{maxRank}) can be configured separately from the rank restriction configuration such as being included as its own IE in CodebookConfig or CSI-ReportConfig.

Once the UE 410 is configured, the base station 420 can send CSI-RS to the UE 410 to perform measurement thereon and generate a CSI report. For example, the CSI-RS is sent by using CSI-RS resources on the different downlink channels.

The UE 410 receives the CSI-RS and performs measurements thereon to then generate and send a CSI report to the base station 420. In addition to including CSI, such as PMI, RI, CQI, CRI, LI, etc., the CSI report can also include mapping information (e.g., layer-to-codeword mapping).

When the UE 410 reports that the UE 410 supports maximum six or eight layer PDSCH reception, for a reduced complexity UE, the CSI report can contain the additional layer to codeword mapping information, one or multiple of restrictions can be considered. In particular, the layer-to-codeword mapping report is enabled if the network (e.g., the base station 420) configures maximum number of layers of CSI report to be greater than four (e.g., “D_{maxRank}>4”). Additionally, or alternatively, the layer-to-codeword mapping report is enabled if the UE 410 reports more than four layer CSI (e.g., in the CSI-report, the UE 410 is including CSI for more than four layers). In both of these cases, the UE 410 can report the number of layers of CSI (e.g., the actual rank) in RI in the reported CSI.

When the UE 410 reports that the UE 410 supports maximum six or eight layer PDSCH reception, for a reduced complexity UE, and when the UE 410 can report the additional layer to codeword mapping, a fixed number of layers can be mapped to a codeword. Here, this mapping indicates the number of layers associated with a codeword (without necessarily identifying these layers). For instance, the mapping indicates that a first codeword is to be processed based on a first subset of the six or more layers and that a second is to be processed based on a second subset of the six or more layers, without necessarily identifying the layers in the two subsets. Consider the illustration of the UE 410 reporting on five, six, seven, or eight layers. In the five layer CSI, the mapping is for “two layers to one codeword and three layers to the other codeword:” the first codeword contains two layers, and the second contains three layers. In the six layer CSI, the mapping is for “three layers to one codeword and three layers to the other codeword:” the first codeword contains three layers, and the second contains three layers. In the seven layer CSI, the mapping is for “three layers to one codeword and four layers to the other codeword:” the first codeword contains three layers, and the second contains four layers. In the eight layer CSI, the mapping is for “four layers to one codeword and four layers to the other codeword:” the first codeword contains four layers, and the second contains four layers.

When the UE 410 reports that the UE 410 supports maximum six or eight layer PDSCH reception, for a reduced complexity UE, and when the UE 410 can report the additional layer to codeword mapping, the CSI can be partitioned to indicate the mapping in at least one part thereof. The bit width and interpretation of the mapping report can on the assumption of the number of layers for PDSCH. For example, the CSI can be partitioned in multiple parts, including a first part (referred to here as part “1”) and a second part (referred to here as past “2”). In one example, the first part has a fixed bit size, while as the second part has a variable bit size and indicates the mapping. The first part indicates a rank (e.g., as the RI). The variable bit size of the second part is based on the rank. Particularly, the bit width and interpretation of the mapping report depends on the rank (e.g., the RI) reported in CSI part “1”. The first part can include the other CSI information (e.g., PMI, RI, CQI, CRI, LI, etc.). The greater the number of reported layers (e.g., the greater the rank indicated in the first part), the greater the bit size of the second part is so that the necessary bits are included in the second part to indicate the mapping. In another example, the two parts are used. But here, the first part (that has a fixed bit size) indicates the mapping. In this example, a bit width and an interpretation of the mapping in the first part are based on at least one of: a first maximum rank indicated by the configuration information (e.g., D_{maxRank}), a second maximum rank indicated by the capability information (e.g., maxNumberMIMO-LayersPDSCH), or a third maximum possible rank (e.g., the maxim number layers or the maximum rank, such as eight, is assumed and the number of bits needed in the first part for the mapping is set according to the maximum rank).

When the UE 410 reports that the UE 410 supports maximum six or eight layer PDSCH reception, for a reduced complexity UE, and when the UE 410 can report the additional layer to codeword mapping, the specific layers associated with a particular codeword can be identified in the CSI report. In an example, the CSI report indicates the mapping by using a bitmap. Each bit of the bitmap corresponds to a layer and a value of the bit indicates whether the layer is mapped to a first codeword or a second codeword. The layer(s) with associated bitmap entry equaling “1” is (are) mapped to the one CW, the layer(s) with bitmap entry equaling “O” is (are) mapped to the other CW. Consider the illustration of the UE 410 reporting on five, six, seven, or eight layers. In the five layer CSI, the bitmap is set to “00101.” As such (from the least significant bit to the most significant bit), the first and third layers in the reported PMI are mapped to one CW, the second, fourth, and fifth layers in the reported PMI are mapped to the other CW. In the six layer CSI, the bitmap is set to “100101.” As such, the first, third, and sixth layers in the reported PMI are mapped to one CW, the second, fourth, and fifth layers in the reported PMI are mapped to the other CW. In the seven layer CSI, the bitmap is set to “0100101.” As such, the first, third, and sixth layers in the reported PMI are mapped to one CW, the second, fourth, fifth, and seventh layers in the reported PMI are mapped to the other CW. In the eight layer CSI, the bitmap is set to “10100101.” As such, the first, third, sixth, and eight layers in the reported PMI are mapped to one CW, the second, fourth, fifth, and seventh layers in the reported PMI are mapped to the other CW. In another example, no bitmap is used. Instead, the CSI report indicates the mapping by using a plurality of bits, where a total number of the used plurality of bits is based on a number of layers associated with the CSI report. Particularly, a combinatorial coefficient “C(R, k)” is used to determine the total number of bits and the values of these bits are set to indicate the particular mapping. “C(R, k)” represents the number of possible selections of choosing “k” layers from “R” layers. Here also consider the illustration of the UE 410 reporting on five, six, seven, or eight layers. In the five layer CSI, a total of “C(5,2)=10” choices are possible. As such, four bits are used to indicate the mapping. In the six layer CSI, a total of “C(6,3)=20” choices are possible. As such, five bits are used to indicate the mapping. In the seven layer CSI, a total of “C(7,3)=35” choices are possible. As such, six bits are used to indicate the mapping. In the eight layer CSI, a total of “C(8,4)=70” choices are possible. As such, seven bits are used to indicate the mapping. This example can reduce the total number of needed bits relative to the bitmap example (e.g., by one bit in each of the different layer cases).

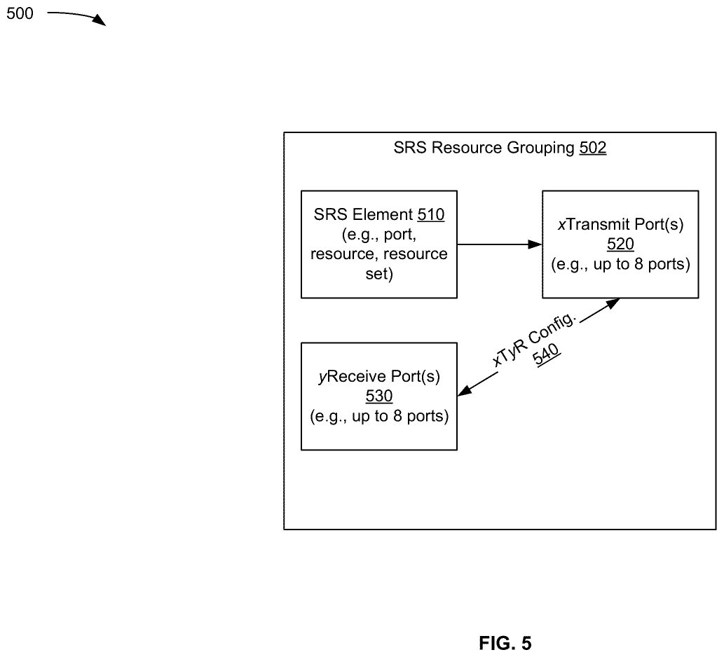

FIG. 5 illustrates an example 500 of grouping of SRS elements and transmit chains in support of SRS transmissions for downlink channel estimations associated with receive chain groups, in accordance with some embodiments. Generally, SRS antenna switching can be implemented such that the network (e.g., a base station thereof) can estimate the channel quality of one or more downlink channels based on uplink channel estimation and on downlink and uplink channel reciprocity. The antenna switching can be represented as xTyR, where “x” and “y” are positive integers and “y≥x.” “x” represents the number of transmit ports (or transmit antennas or transmit chains) used on the uplink and “y” represents the number receive ports (or receive antennas or receive chains) used on the downlink having reciprocity with the uplink. If “x” is one, the uplink includes one uplink channel. If “x” is more than one, the uplink includes more than one uplink channel. Similarly, if “y” is one, the downlink includes one downlink channel (equivalently, one layer for PDSCH reception). If “y” is more than one, the downlink includes more than one downlink channel (equivalently, more than one layer for PDSCH reception). As such, for xTyR SRS with antenna switching, the UE sounds “y” receive ports with “x” transmit ports. In particular, the UE sends SRS using the “x” transmit ports. These “x” transmit ports corresponding to “x” uplink channels. The base station estimates the “x” uplink channels. The channel quality of “y” reciprocal downlink channels is assumed to be the same as the uplink channel estimation. These “y” downlink channels correspond to “y” receive ports of the UE.

For six layer and eight layer receptions (6Rx and 8Rx), the following SRS antenna switching can be supported. 1T6R, 2T6R, 1T8R, 2T8R, 4T8R, and 8T8R. With 1T6R, six SRS resources can be transmitted sequentially using one transmit port to sound six receive ports. With 2T6R, three SRS resources can be transmitted sequentially to sound six receive ports, where each transmission uses two transmit ports. With 1T8R, eight SRS resources can be transmitted sequentially using one transmit port to sound eight receive ports. With 2T8R, four SRS resources can be transmitted sequentially to sound eight receive ports, where each transmission uses two transmit ports. With 4T8R, two SRS resources can be transmitted sequentially to sound eight receive ports, where each transmission uses four transmit ports. With 8T8R, one SRS resource can be transmitted to sound eight receive ports, where the transmission uses eight transmit ports.

In the case of a base station, the base station needs to determine the precoding to apply to a codeword sent on the “y” downlink channels that correspond to the “y” receive ports of the UE, where these receive ports are associated with “x” transmit ports for the purpose of SRS sounding using antenna switching. As such, the base station needs to determine an SRS resource grouping that indicates that a same SRS resource is associated with a group of different SRS ports. Similarly, the UE needs to determine such an SRS resource grouping for its processing of the codeword when this codeword is received. Information about the SRS resource grouping can be exchanged between the base station and the UE (e.g., via RRC signaling) or can be defined in a technical specification with which both the base station and the UE comply (e.g., in which case, the information exchange may not be needed).

When the UE reports that it supports maximum six or eight layer PDSCH reception, for a reduced complexity, SRS enhancement can be considered to group different receive ports. This grouping (referred to herein as SRS resource grouping) can be at different levels. In one example, the SRS resource grouping indicates that a same SRS resource is associated with a group of different SRS ports (e.g., in the same SRS-Resource, different SRS ports are grouped). In another example, the SRS resource grouping indicates that a same SRS resource set is associated with a group of different SRS resources (e.g., in the same SRS-ResourceSet, different SRS-Resources are grouped). In a further example, the SRS resource grouping indicates that a subset of the six or more layers for the PDSCH reception is associated with a group of different SRS resource sets (e.g., in the same subset of layers, different SRS-ResourceSets are grouped).

As shown in FIG. 5, SRS resource grouping 502 associates an SRS element 510 with “x” transmit ports 520 and “y” receive ports 530 in an xTyR configuration 540 for SRS antenna switching. The SRS element 510 can be one or more transmit ports (in which case the SRS element 510 and the “x” transmit ports 520 are the same), one or more SRS resources, or one or more SRS resource sets.

Referring back to the illustrations of 1T6R, 2T6R, 1T8R, 2T8R, 4T8R, and 8T8R, the following information can be indicated by the SRS resource grouping 502. For 1T6R, six receive ports are sounded with six SRS resources. Two groups can be indicated, each corresponding to three SRS resources and three receive ports. For 2T6R, six receive ports are sounded with three SRS resources. Two groups can be indicated, one group corresponding to three SRS resources and three receive ports, and the other one corresponding to the other three SRS resources and three receive ports. For 1T8R, eight receive ports are sounded with eight SRS resources. Two groups can be indicated, each corresponding to four SRS resources and four receive ports. For 2T8R, eight receive ports are sounded with four SRS resources. Two groups can be indicated, one corresponding to four SRS resources and four receive ports. With 4T8R, eight receive ports are sounded with two SRS resources. Two groups can be indicated, one corresponding to one SRS resource and four receive ports. With 8T8R, eight receive ports are sounded with one SRS resource. Two groups can be indicated, each corresponding to four receive ports.

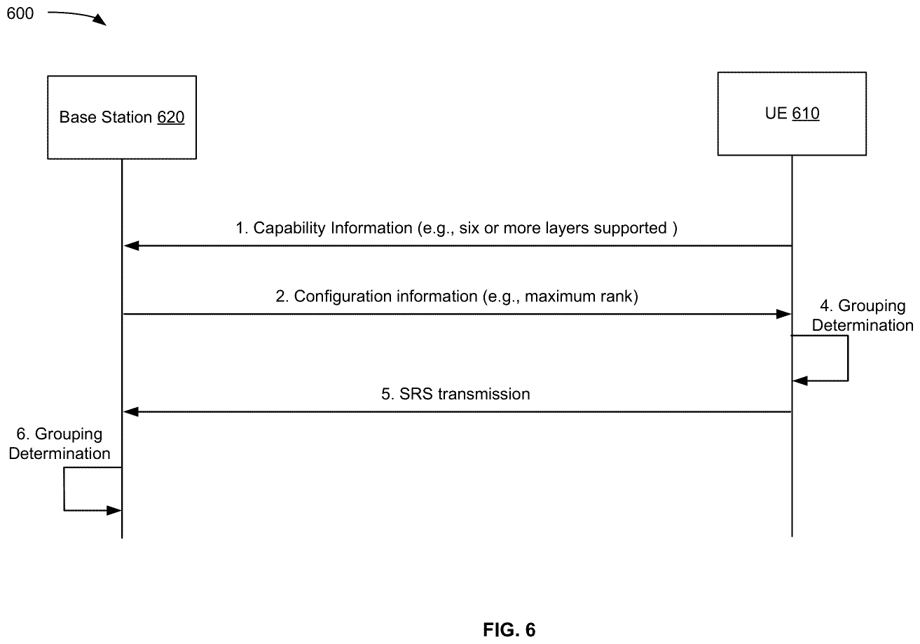

FIG. 6 illustrates an example 600 of a sequence diagram between a UE 610 and a base station 620 in support of SRS transmissions for downlink channel estimations associated with receive chain groups, in accordance with some embodiments. As illustrated, the UE 610 sends capability information to the base station 620 (e.g., via radio resource control (RRC) signaling). Similar to the example 400 of FIG. 4, the capability information reports the maximum number of layers for PDSCH reception that the UE 610 supports. In an example, this number is more than four (e.g., six, eight, or a different positive integer greater than four). Next, the base station 620 sends configuration information to the UE 610 based on the capability information. Similar to the example 400 of FIG. 4, the configuration information can configure the UE 610 to use a certain number of layers (e.g., up to the maximum number that it supports) for PDSCH reception.

Given the number of configured layers or the number of layers the UE 610 is to use, the UE can determine SRS grouping information. This SRS grouping information need not be signaled from the base station (e.g., via RRC signaling). Instead, the SRS grouping information can be stored in a memory of the UE 610, whereby this information is defined according to a technical specification with which both the UE 610 and the base station 620 comply and can be looked up from the memory given the number of layers and/or an xTyR configuration of the UE. Based on the SRS grouping information (e.g., that a certain SRS resource is associated with a certain group of receive ports), the UE 610 can send an SRS transmission to the base station 620. The SRS transmission can include the SRS resource on one or more uplink channels depending on the xTyR configuration of the UE 610, where some or all of the “y” receive ports are grouped together by the grouping information and are associated with the SRS resource. Upon receiving the SRS transmission, the base station 620 can process it by processing at least the SRS resource. To do so, the base station 620 can also determine the SRS grouping information. Here also, the SRS grouping information can be stored in a memory of the base station 620, whereby this information is defined according to the technical specification and can be looked up from the memory given the number of configured layers and/or an xTyR configuration of the UE. The SRS transmission processing can include performing different types of measurements (e.g., reference signal received power (RSRP), reference signal received quality (RSRQ), etc.) to determine the relevant precoding information per group of layers (or, correspondingly, “y” receive ports of the UE 610). The precoding information is then used in the processing of a codeword mapped to a group of layers.

In an example, when the UE 610 reports that its supports maximum six or eight layer PDSCH reception, for a reduced complexity UE, SRS enhancement can be considered to group different receive ports for 1T6R. In one option, in one SRS-ResourceSet with usage set to “antennaSwitching,” six SRS-Resources are configured. Three of the six SRS-Resources are grouped together and may be associated with three receive ports of the six receive ports. Further, the last three SRS-Resources are grouped together and may be associated with the remaining three receive ports. In this option, the order of SRS-Resource can be determined based on the SRS-ResourceId (e.g., the three SRS resources with the three smallest identifiers are associated with the first group), or the order of SRS-Resource configured in the corresponding SRS-ResourceSet. In another options, in two SRS-ResourceSets with usage set to “antennaSwitching,” three SRS-Resources are configured in each SRS-ResourceSet. The first SRS-ResourceSet corresponds to the first group that may be associated with three of the six receive ports, and the second SRS-ResourceSet corresponds to the second group that may be associated with the remaining three receive ports.

In an example, when the UE 610 reports that its supports maximum six or eight layer PDSCH reception, for a reduced complexity UE, SRS enhancement can be considered to group different receive ports for 2T6R. In one option, in one SRS-ResourceSet with usage set to “antennaSwitching,” three SRS-Resources are configured. These three SRS-Resources are grouped together and may be associated with three receive ports of the six receive ports. In another SRS-ResourceSet with usage set to “antennaSwitching,” three other SRS-Resources are configured. Here also, the three SRS-Resources are grouped together and may be associated with the remaining three receive ports. In this option, the order of SRS-Resource can be determined based on the SRS-ResourceId, or the order of SRS-Resource configured in the corresponding SRS-ResourceSet. In another options, the first SRS-ResourceSet corresponds to the first group that may be associated with three of the six receive ports, and the second SRS-ResourceSet corresponds to the second group that may be associated with the remaining three receive ports.

In an example, when the UE 610 reports that its supports maximum six or eight layer PDSCH reception, for a reduced complexity UE, SRS enhancement can be considered to group different receive ports for 1TR8. In one option, in an SRS-ResourceSet with usage set to “antennaSwitching,” eight SRS-Resources are configured. Four of the eight SRS-Resources (e.g., the first four SRS-Resources) are grouped together and this group may be associated with a group or receive ports. The remaining four SRS-Resource (e.g., the last four SRS-Resources) are grouped together and this group may be associated with a different group or receive ports. In this option, the order of SRS-Resource can be determined based on the SRS-ResourceId, or the order of SRS-Resource configured in the corresponding SRS-ResourceSet. In another options, in two SRS-ResourceSet with usage set to “antennaSwitching,” four SRS-Resources are configured in each SRS-ResourceSet. The first SRS-ResourceSet corresponds to the first group, and the second SRS-ResourceSet corresponds to the second group.

In an example, when the UE 610 reports that its supports maximum six or eight layer PDSCH reception, for a reduced complexity UE, SRS enhancement can be considered to group different receive ports for 2TR8. In one option, in an SRS-ResourceSet with usage set to “antennaSwitching,” four SRS-Resources are configured. Two SRS-Resources (e.g., the first two SRS-Resources) are grouped together and may be associated with a group of receive ports. The other two 4 SRS-Resources (e.g., the last two SRS-Resources) are grouped together and may be associated with a different group of receive ports. In this option, the order of SRS-Resource can be determined based on the SRS-ResourceId, or the order of SRS-Resource configured in the corresponding SRS-ResourceSet. In another options, in two SRS-ResourceSet with usage set to “antennaSwitching,” two SRS-Resources are configured in each SRS-ResourceSet. The first SRS-ResourceSet corresponds to the first group, and the second SRS-ResourceSet corresponds to the second group.

In an example, when the UE 610 reports that its supports maximum six or eight layer PDSCH reception, for a reduced complexity UE, SRS enhancement can be considered to group different receive ports for 4TR8. In one option, in an SRS-ResourceSet with usage set to “antennaSwitching,” two SRS-Resources are configured. One of the two SRS-Resources (e.g., the first SRS-Resource) is associated with a group of receive ports. The other SRS-Resource (e.g., the last SRS-Resource) is associated with a different group of receive ports. In this option, the order of SRS-Resource can be determined based on the SRS-ResourceId, or the order of SRS-Resource configured in the corresponding SRS-ResourceSet. In another options, in two SRS-ResourceSets with usage set to “antennaSwitching,” one SRS-Resource is configured in each SRS-ResourceSet. The first SRS-ResourceSet corresponds to the first group, and the second SRS-ResourceSet corresponds to the second group.

In an example, when the UE 610 reports that its supports maximum six or eight layer PDSCH reception, for a reduced complexity UE, SRS enhancement can be considered to group different receive ports for 8TR8. In one option, in a SRS-ResourceSet with usage set to “antennaSwitching,” one SRS-Resource is configured with eight ports. Four SRS ports (e.g., the first four SRS ports), or equivalently four receive ports, are grouped together. The other four SRS ports (e.g., the last 4 SRS ports), or equivalently the four remaining receive ports, are grouped together.

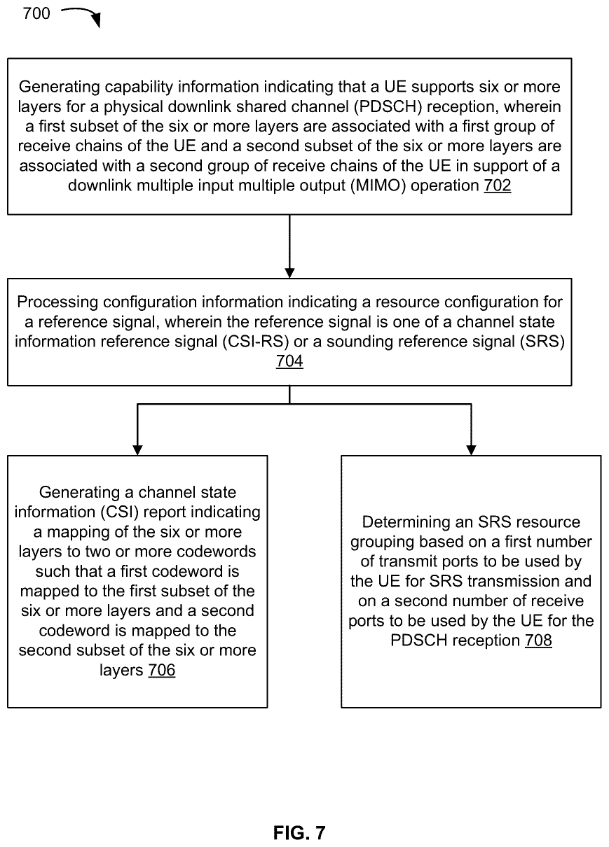

FIG. 7 illustrates an example of an operational flow/algorithmic structure 700 for a reduced complexity UE to support downlink channel estimations, in accordance with some embodiments. The operation flow/algorithmic structure 700 may be performed or implemented by the UE, such as any of the UEs described herein, or components thereof, for example, processors 1004.

The operation flow/algorithmic structure 700 may include, at 702, generating capability information indicating that the UE supports six or more layers for a physical downlink shared channel (PDSCH) reception, wherein a first subset of the six or more layers are associated with a first group of receive chains of the UE and a second subset of the six or more layers are associated with a second group of receive chains of the UE in support of a downlink multiple input multiple output (MIMO) operation. The capability information can include an IE that indicates the number of layers that the UE supports. This IE can be a ax NumberMIMO-LayersPDSCH reported per FSPC and include “sixLayers” as explicit value when the UE supports six layers.

The operation flow/algorithmic structure 700 may include, at 704, processing configuration information indicating a resource configuration for a reference signal, wherein the reference signal is one of a channel state information reference signal (CSI-RS) or a sounding reference signal (SRS). The configuration information can also configure the UE to use a particular number of layers (e.g., a maximum rank per FSPC). The maximum rank can be included in CodebookConfig or CSI-ReportConfig.

The operation flow/algorithmic structure 700 may include, at 706, generating a channel state information (CSI) report indicating a mapping of the six or more layers to two or more codewords such that a first codeword is mapped to the first subset of the six or more layers and a second codeword is mapped to the second subset of the six or more layers. For example, CSI-RS is received by the UE from the base station and measurements thereon are performed to generate the CSI report. This report can indicate the number of layers to be mapped to a codeword (without identifying these layers) and/or can identify the specific layers mapped to the codeword by using a bitmap or particular bits in a first part or a second part of the CSI report.

The operation flow/algorithmic structure 700 may include, at 708, determining an SRS resource grouping based on a first number of transmit ports to be used by the UE for SRS transmission and on a second number of receive ports to be used by the UE for the PDSCH reception. For example, this grouping can be determined from a memory of the UE and can be used to associate an uplink SRS transmission with a set of receive ports.

Operations 706-708 can be performed alternative to each other or in conjunction with each other (in which case, they can be performed in parallel or sequentially).

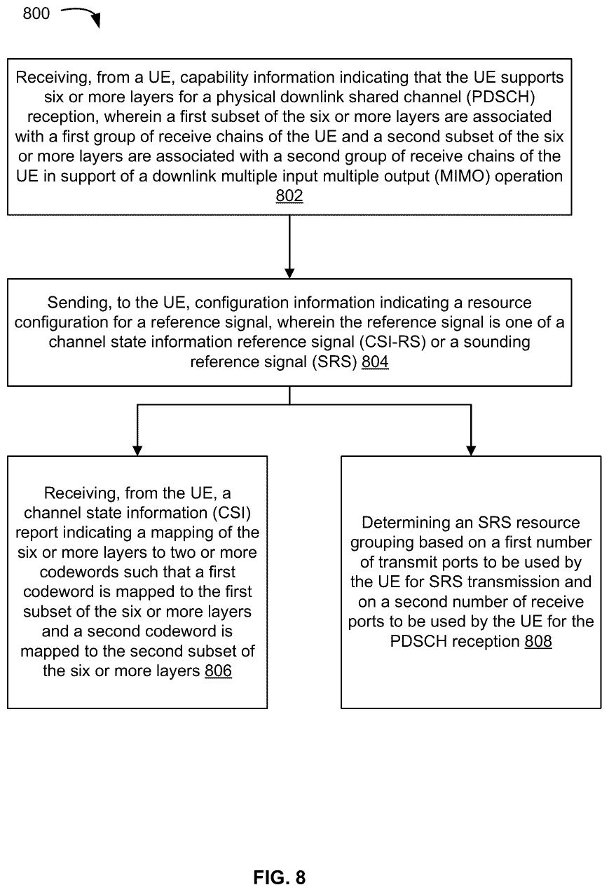

FIG. 8 illustrates an example of an operational flow/algorithmic structure 800 for a base station to support downlink channel estimations for communications with a reduced complexity UE, in accordance with some embodiments. The operation flow/algorithmic structure 800 may be performed or implemented by the base station, such as any of the base station described herein, or components thereof, for example, processors 1104.

The operation flow/algorithmic structure 800 may include, at 802, receiving, from a UE, capability information indicating that the UE supports six or more layers for a physical downlink shared channel (PDSCH) reception, wherein a first subset of the six or more layers are associated with a first group of receive chains of the UE and a second subset of the six or more layers are associated with a second group of receive chains of the UE in support of a downlink multiple input multiple output (MIMO) operation. The capability information can be received via RRC signaling and can include an IE that indicates the number of layers that the UE supports. This IE can be a axNumberMIMO-LayersPDSCH reported per FSPC and include “sixLayers” as explicit value when the UE supports six layers.

The operation flow/algorithmic structure 800 may include, at 804, sending, to the UE, configuration information indicating a resource configuration for a reference signal, wherein the reference signal is one of a channel state information reference signal (CSI-RS) or a sounding reference signal (SRS). The configuration information can be sent via RRC signaling and configure the UE to use a particular number of layers (e.g., a maximum rank per FSPC). The maximum rank can be included in CodebookConfig or CSI-ReportConfig.

The operation flow/algorithmic structure 800 may include, at 806, receiving, from the UE, a channel state information (CSI) report indicating a mapping of the six or more layers to two or more codewords such that a first codeword is mapped to the first subset of the six or more layers and a second codeword is mapped to the second subset of the six or more layers. For example, the base station sends CSI-RS to the UE that then performs measurements thereon to generate the CSI report. This report is sent from the UE and can indicate the number of layers to be mapped to a codeword (without identifying these layers) and/or can identify the specific layers mapped to the codeword by using a bitmap or particular bits in a first part or a second part of the CSI report.

The operation flow/algorithmic structure 800 may include, at 808, determining an SRS resource grouping based on a first number of transmit ports to be used by the UE for SRS transmission and on a second number of receive ports to be used by the UE for the PDSCH reception. For example, this grouping can be determined from a memory of the base station and can be used to associate an uplink SRS transmission with a set of receive ports of the UE (e.g., without necessarily identifying these ports, or equivalently, associated with layers).

Operations 806-808 can be performed alternative to each other or in conjunction with each other (in which case, they can be performed in parallel or sequentially).

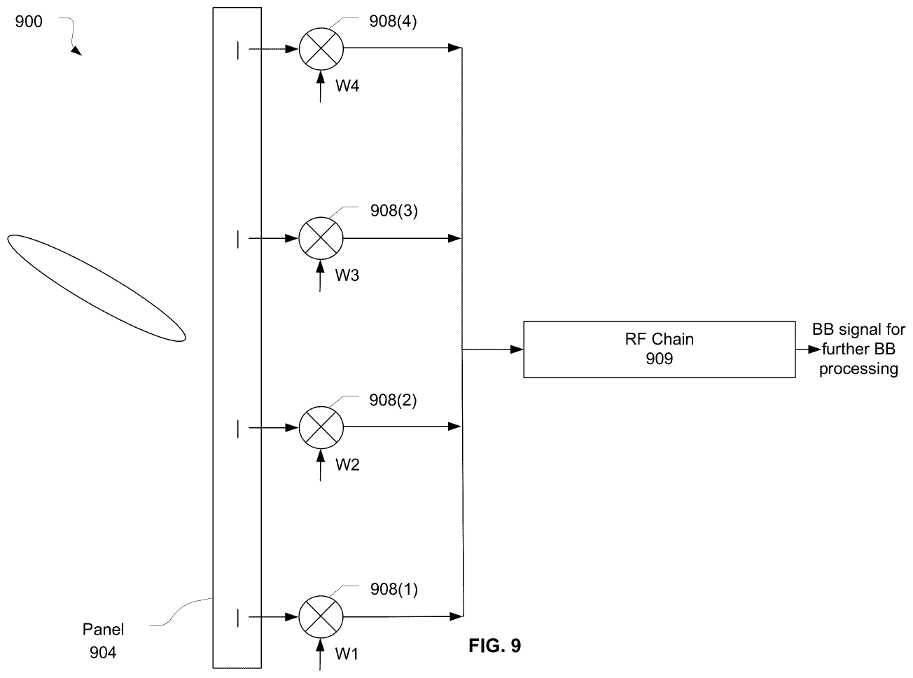

FIG. 9 illustrates receive components 900 of a UE 104 (e.g., the UE 104 of FIG. 1 and any other UE described herein), in accordance with some embodiments. The receive components 900 may include an antenna panel 904 that includes a number of antenna elements. The panel 904 is shown with four antenna elements, but other embodiments may include other numbers. Multiple antenna panels may also be included.

The antenna panel 904 may be coupled to analog beamforming (BF) components that include a number of phase shifters 908(1)-908(4). The phase shifters 908(1)-908(4) may be coupled with a radio-frequency (RF) chain 909. The RF chain 909 may amplify a receive analog RF signal, down-convert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values to the phase shifters 908(1)-908(4) to provide a receive beam at the antenna panel 904. These BF weights may be determined based on the channel-based beamforming.

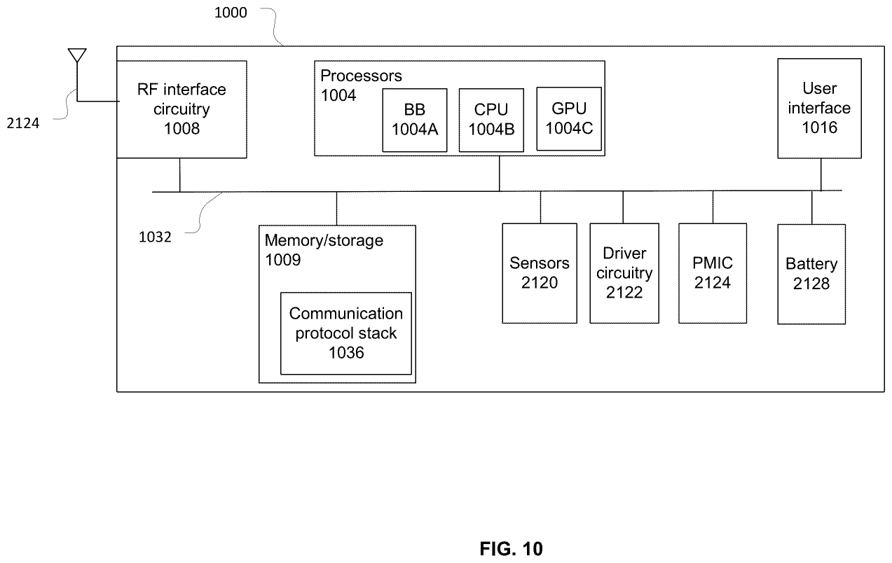

FIG. 10 illustrates a UE 1000, in accordance with some embodiments. The UE 1000 may be similar to and substantially interchangeable with the UE 104 of FIG. 1 and any other UE described herein.

Similar to that described above with respect to UE 104, the UE 1000 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, and actuators), video surveillance/monitoring devices (for example, cameras and video cameras), wearable devices, or relaxed-IoT devices. In some embodiments, the UE may be a reduced capacity UE or NR-Light UE.

The UE 1000 may include processors 1004, RF interface circuitry 1008, memory/storage 1009, user interface 1016, sensors 1020, driver circuitry 1022, power management integrated circuit (PMIC) 1024, and battery 1028. The components of the UE 1000 may be implemented as integrated circuits (ICs), portions thereof, discrete electronic devices, or other modules, such as logic, hardware, software, firmware, or a combination thereof. The block diagram of FIG. 10 is intended to show a high-level view of some of the components of the UE 1000. However, some of the components shown may be omitted, additional components may be present, and different arrangements of the components shown may occur in other implementations.

The components of the UE 1000 may be coupled with various other components over one or more interconnects 1032 which may represent any type of interface, input/output, bus (local, system, or expansion), transmission line, trace, optical connection, etc. that allows various circuit components (on common or different chips or chipsets) to interact with one another.

The processors 1004 may include processor circuitry, such as baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1009 to cause the UE 1000 to perform operations as described herein.

In some embodiments, the baseband processor circuitry 1004A may access a communication protocol stack 1036 in the memory/storage 1009 to communicate over a 3GPP compatible network. In general, the baseband processor circuitry 1004A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on cyclic prefix OFDM (CP-OFDM) in the uplink or downlink and discrete Fourier transform spread OFDM (DFT-S-OFDM) in the uplink.

The baseband processor circuitry 1004A may also access group information 1024 from memory/storage 1009 to determine search space groups in which a number of repetitions of a PDCCH may be transmitted.

The memory/storage 1012 may include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include switches, mixers, amplifiers, filters, synthesizer circuitry, control circuitry, etc.

In the receive path, the RFEM may receive a radiated signal from an air interface via an antenna 1024 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1024.

In various embodiments, the RF interface circuitry 1008 may be configured to transmit/receive signals in a manner compatible with NR access technologies.

The antenna 1024 may include a number of antenna elements that each convert electrical signals into radio waves to travel through the air and to convert received radio waves into electrical signals. The antenna elements may be arranged into one or more antenna panels. The antenna 1024 may have antenna panels that are omnidirectional, directional, or a combination thereof to enable beamforming and multiple input multiple output communications. The antenna 1024 may include micro-strip antennas, printed antennas that are fabricated on the surface of one or more printed circuit boards, patch antennas, phased array antennas, etc. The antenna 1024 may have one or more panels designed for specific frequency bands including bands in FR1 or FR2.

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs)) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example, cameras or lens-less apertures); light detection and ranging sensors; proximity sensors (for example, infrared radiation detector and the like); depth sensors; ambient light sensors; ultrasonic transceivers; microphones or other like audio capture devices; etc.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within or connected to the UE 1000. For example, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, or audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1000 may power down for brief intervals of time and thus, save power. If there is no data traffic activity for an extended period of time, then the UE 1000 may transition off to an RRC_Idle state, where it disconnects from the network and does not perform operations, such as channel quality feedback, handover, etc. The UE 1000 goes into a very low power state, and it performs paging where again it periodically wakes up to listen to the network and then powers down again. The UE 1000 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay, and it is assumed the delay is acceptable.

A battery 1028 may power the UE 1000, although in some examples the UE 1000 may be mounted deployed in a fixed location and may have a power supply coupled to an electrical grid. The battery 1028 may be a lithium-ion battery, a metal-air battery, such as a zinc-air battery, an aluminum-air battery, a lithium-air battery, and the like. In some implementations, such as in vehicle-based applications, the battery 1028 may be a typical lead-acid automotive battery.

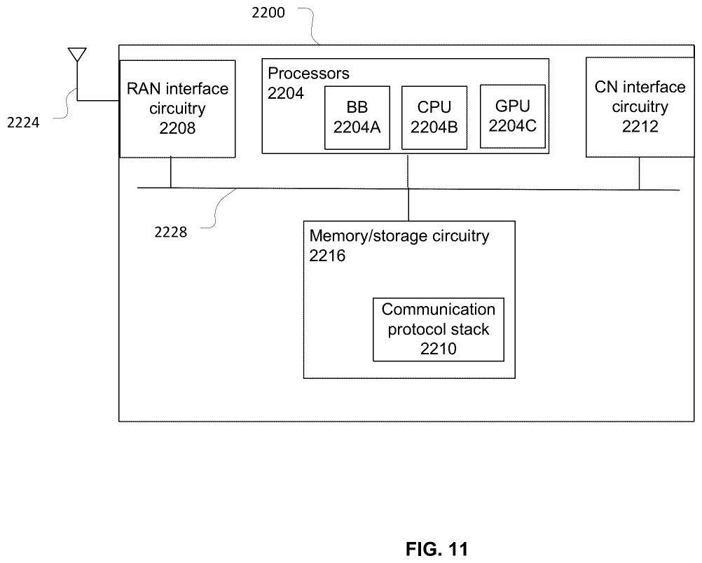

FIG. 11 illustrates a gNB 1100, in accordance with some embodiments.

The gNB node 1100 may be similar to and substantially interchangeable with a base station (e.g., gNB 108) and/or components thereof can be included in a TRP.

The gNB 1100 may include processors 1104, RF interface circuitry 1108, core network (CN) interface circuitry 1112, and memory/storage circuitry 1116.

The components of the gNB 1100 may be coupled with various other components over one or more interconnects 1128.

The processors 1104, RF interface circuitry 1108, memory/storage circuitry 1116 (including communication protocol stack 1110), antenna 1124, and interconnects 1128 may be similar to like-named elements shown and described with respect to FIGS. 9 and 10.

The CN interface circuitry 1112 may provide connectivity to a core network, for example, a 5th Generation Core network (5GC) using a 5GC-compatible network interface protocol, such as carrier Ethernet protocols or some other suitable protocol. Network connectivity may be provided to/from the gNB 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate, in accordance with one or more of the examples set forth below. For another example, circuitry associated with a UE, base station, network element, etc., as described above in connection with one or more of the preceding figures, may be configured to operate in accordance with one or more of the examples set forth below in the example section.

### Examples

In the following sections, further exemplary embodiments are provided.

Example 1 includes a method implemented by a user equipment (UE), the method comprises generating capability information indicating that the UE supports six or more layers for a physical downlink shared channel (PDSCH) reception, wherein a first subset of the six or more layers are associated with a first group of receive chains of the UE and a second subset of the six or more layers are associated with a second group of receive chains of the UE in support of a downlink multiple input multiple output (MIMO) operation; processing configuration information indicating a resource configuration for a reference signal, wherein the reference signal is one of a channel state information reference signal (CSI-RS) or a sounding reference signal (SRS); and performing at least one of: generating a channel state information (CSI) report indicating a mapping of the six or more layers to two or more codewords such that a first codeword is mapped to the first subset of the six or more layers and a second codeword is mapped to the second subset of the six or more layers, or determining an SRS resource grouping based on a first number of transmit ports to be used by the UE for SRS transmission and on a second number of receive ports to be used by the UE for the PDSCH reception.

Example 2 includes a method implemented by a base station, the method comprising: receiving, from a UE, capability information indicating that the UE supports six or more layers for a physical downlink shared channel (PDSCH) reception, wherein a first subset of the six or more layers are associated with a first group of receive chains of the UE and a second subset of the six or more layers are associated with a second group of receive chains of the UE in support of a downlink multiple input multiple output (MIMO) operation; sending, to the UE, configuration information indicating a resource configuration for a reference signal, wherein the reference signal is one of a channel state information reference signal (CSI-RS) or a sounding reference signal (SRS); and performing at least one of: receiving, from the UE, a channel state information (CSI) report indicating a mapping of the six or more layers to two or more codewords such that a first codeword is mapped to the first subset of the six or more layers and a second codeword is mapped to the second subset of the six or more layers, or determining an SRS resource grouping based on a first number of transmit ports to be used by the UE for SRS transmission and on a second number of receive ports to be used by the UE for the PDSCH reception.

Example 3 includes the method of any preceding example, wherein the capability information includes an information element indicating that the UE supports six layers for the downlink MIMO operation.

Example 4 includes the method of any preceding example, wherein the configuration information indicates a maximum rank that the UE is to use for generating the CSI report, wherein the maximum rank is indicated by a bitmap in a rank restriction information element or is indicated separately from the rank restriction information element.

Example 5 includes the method of any preceding example, wherein the mapping is indicated in the CSI report upon a determination that the configuration information indicates that a maximum number of layers that UE can report for CSI is more than four layers or upon a determination that the UE reports more than four layers in the CSI report.

Example 6 includes the method of any preceding example, wherein the mapping indicates that the first codeword is to be processed based on the first subset of the six or more layers and that the second codeword is to be processed based on the second subset of the six or more layers.

Example 7 includes the method of any preceding example, wherein the CSI report includes a first part and a second part, wherein the first part has a fixed bit size, wherein the second part has a variable bit size and indicates the mapping.

Example 8 includes the method of example 8, wherein the first part indicates a rank, and wherein the variable bit size is based on the rank.

Example 9 includes the method of any preceding example 1-6, wherein the CSI report includes a first part and a second part, wherein the first part has a fixed bit size and indicates the mapping.

Example 10 includes the method of example 9, wherein a bit width and an interpretation of the mapping in the first part are based on at least one of: a first maximum rank indicated by the configuration information, a second maximum rank indicated by the capability information, or a third maximum possible rank.

Example 11 includes the method of any preceding example, wherein the CSI report indicates the mapping by using a bitmap, wherein a bit of the bitmap corresponds to a layer and a value of the bit indicates whether the layer is mapped to a first codeword or a second codeword.

Example 12 includes the method of any preceding example 1-10, wherein the CSI report indicates the mapping by using a plurality of bits, wherein a total number of the used plurality of bits is based on a number of layers associated with the CSI report.

Example 13 includes the method of example of any preceding example, wherein the SRS resource grouping indicates that a same SRS resource is associated with a plurality of groups, each one of the plurality of groups corresponding to different SRS ports.

Example 14 includes the method of any preceding example, wherein the SRS resource grouping includes a plurality of groups each associated with different SRS resources.

Example 15 includes the method of any preceding example, wherein the SRS resource grouping includes a plurality of groups each associated with different SRS resource sets.

Example 16 includes the method of any preceding example, wherein the first number is one and the second number is six, and wherein the SRS resource grouping indicates at least one of: a first plurality of three SRS resources are grouped together and a second plurality of three SRS resources are grouped together, or a first SRS resource set that includes three SRS resources corresponds to a first group of three receive ports and a second SRS resource set that includes three other SRS resources corresponds to a second group of three receive ports.

Example 17 includes the method of any preceding example 1-15, wherein the first number is one and the second number is eight, and wherein the SRS resource grouping indicates at least one of: a first plurality of four SRS resources are grouped together and a second plurality of four SRS resources are grouped together, or a first SRS resource set that includes four SRS resources corresponds to a first group of four receive ports and a second SRS resource set that includes four other SRS resources corresponds to a second group of four receive ports.

Example 18 includes the method of any preceding example 1-15, wherein the first number is two and the second number is eight, and wherein the SRS resource grouping indicates at least one of: a first plurality of two SRS resources are grouped together and a second plurality of two SRS resources are grouped together, or a first SRS resource set that includes two SRS resources corresponds to a first group of four receive ports and a second SRS resource set that includes two other SRS resources corresponds to a second group of four receive ports.

Example 19 includes the method of any preceding example 1-15, wherein the first number is four and the second number is eight, and wherein the SRS resource grouping indicates at least one of: a first group of one SRS resource and a second group of SRS resource, or a first SRS resource set that includes one SRS corresponds to a first group of four receive ports and a second SRS resource set that includes another SRS resource corresponds to a second group of four receive ports.

Example 20 includes the method of any preceding example 1-15, wherein the first number is eight and the second number is eight, and wherein the SRS resource grouping indicates that a first plurality of four SRS ports associated with an SRS resource are grouped together and a second plurality of four SRS ports also associated with the SRS resource are grouped together.

Example 21 includes a user equipment (UE) comprising: one or more processors; and one or more memory storing instructions that, upon execution by the one or more processors, configure the UE to perform the method of any preceding example.

Example 22 includes one or more computer-readable media storing instructions that, when executed on a user equipment (UE), cause the UE to perform operations comprising those of the method of any preceding example.

Example 23 includes a device comprising means to perform one or more elements of a method described in or related to any of the preceding examples.

Example 24 includes one or more non-transitory computer-readable media comprising instructions to cause a device, upon execution of the instructions by one or more processors of the device, to perform one or more elements of a method described in or related to any of the preceding examples.

Example 25 includes a device comprising logic, modules, or circuitry to perform one or more elements of a method described in or related to any of the preceding examples.

Example 26 includes a device comprising: one or more processors and one or more computer-readable media comprising instructions that, when executed by the one or more processors, cause the one or more processors to perform one or more elements of a method described in or related to any of the preceding examples.

Example 27 includes a system comprising means to perform one or more elements of a method described in or related to any of the preceding examples.

Example 28 includes an apparatus comprising: processing circuitry to perform one or more elements of the method described in or related to any of the preceding examples, or any other method or process describe herein; and interface circuitry, coupled with the processing circuitry, the interface circuitry to communicatively couple the processing circuitry to one or more components of a computing platform.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Applicant hereby claims:

1. An apparatus comprising:
processing circuitry configured to:
determine capability information indicating support for six or more layers for a physical downlink shared channel (PDSCH) reception, wherein a first subset of the six or more layers are associated with a first group of receive chains and a second subset of the six or more layers are associated with a second group of receive chains in support of a downlink multiple input multiple output (MIMO) operation;
process configuration information indicating a resource configuration for a reference signal, wherein the reference signal is one of a channel state information reference signal (CSI-RS) or a sounding reference signal (SRS); and
perform at least one of:
generating a channel state information (CSI) report indicating a mapping of the six or more layers to two or more codewords such that a first codeword is mapped to the first subset of the six or more layers and a second codeword is mapped to the second subset of the six or more layers, or
determining an SRS resource grouping based on a first number of transmit ports to be used for SRS transmission and on a second number of receive ports to be used for the PDSCH reception; and
interface circuitry coupled with the processing circuitry to enable communication.

2. The apparatus of claim 1, wherein the capability information includes an information element indicating support for six layers for the downlink MIMO operation.

3. The apparatus of claim 1, wherein the configuration information indicates a maximum rank to use for generating the CSI report, wherein the maximum rank is indicated by a bitmap in a rank restriction information element or is indicated separately from the rank restriction information element.

4. The apparatus of claim 1, wherein the mapping is indicated in the CSI report upon a determination that the configuration information indicates that a maximum number of layers that can be reported for CSI is more than four layers or upon a determination that more than four layers are reported in the CSI report.

5. The apparatus of claim 1, wherein the mapping indicates that the first codeword is to be processed based on the first subset of the six or more layers and that the second codeword is to be processed based on the second subset of the six or more layers.

6. The apparatus of claim 1, wherein the CSI report includes a first part and a second part, wherein the first part has a fixed bit size, wherein the second part has a variable bit size and indicates the mapping.

7. The apparatus of claim 6, wherein the first part indicates a rank, and wherein the variable bit size is based on the rank.

8. The apparatus of claim 1, wherein the CSI report includes a first part and a second part, wherein the first part has a fixed bit size and indicates the mapping.

9. The apparatus of claim 1, wherein the CSI report indicates the mapping by using a bitmap, wherein a bit of the bitmap corresponds to a layer and a value of the bit indicates whether the layer is mapped to a first codeword or a second codeword.

10. The apparatus of claim 1, wherein the CSI report indicates the mapping by using a plurality of bits, wherein a total number of the used plurality of bits is based on a number of layers associated with the CSI report.

11. One or more computer-readable storage media storing instructions that, upon execution by one or more processors, cause the one or more processors to perform operations comprising:
determining capability information indicating support for six or more layers for a physical downlink shared channel (PDSCH) reception, wherein a first subset of the six or more layers are associated with a first group of receive chains and a second subset of the six or more layers are associated with a second group of receive chains in support of a downlink multiple input multiple output (MIMO) operation;
processing configuration information indicating a resource configuration for a reference signal, wherein the reference signal is one of a channel state information reference signal (CSI-RS) or a sounding reference signal (SRS); and
performing at least one of:
generating a channel state information (CSI) report indicating a mapping of the six or more layers to two or more codewords such that a first codeword is mapped to the first subset of the six or more layers and a second codeword is mapped to the second subset of the six or more layers, or
determining an SRS resource grouping based on a first number of transmit ports to be used for SRS transmission and on a second number of receive ports to be used for the PDSCH reception.

12. The one or more computer-readable storage media of claim 11, wherein the SRS resource grouping indicates that a same SRS resource is associated with a plurality of groups, each one of the plurality of groups corresponding to different SRS ports.

13. The one or more computer-readable storage media of claim 11, wherein the SRS resource grouping includes a plurality of groups each associated with different SRS resources.

14. The one or more computer-readable storage media of claim 11, wherein the SRS resource grouping includes a plurality of groups each associated with different SRS resource sets.

15. A method comprising:
processing capability information received from a user equipment (UE) and indicating that the UE supports six or more layers for a physical downlink shared channel (PDSCH) reception, wherein a first subset of the six or more layers are associated with a first group of receive chains of the UE and a second subset of the six or more layers are associated with a second group of receive chains of the UE in support of a downlink multiple input multiple output (MIMO) operation;
generating, for transmission to the UE, of configuration information indicating a resource configuration for a reference signal, wherein the reference signal is one of a channel state information reference signal (CSI-RS) or a sounding reference signal (SRS); and
performing at least one of:
processing a channel state information (CSI) report received from the UE and indicating a mapping of the six or more layers to two or more codewords such that a first codeword is mapped to the first subset of the six or more layers and a second codeword is mapped to the second subset of the six or more layers, or
determining an SRS resource grouping based on a first number of transmit ports to be used by the UE for SRS transmission and on a second number of receive ports to be used by the UE for the PDSCH reception.

16. The method of claim 15, wherein the first number is one and the second number is six, and wherein the SRS resource grouping indicates at least one of: a first plurality of three SRS resources are grouped together and a second plurality of three SRS resources are grouped together, or a first SRS resource set that includes three SRS resources corresponds to a first group of three receive ports and a second SRS resource set that includes three other SRS resources corresponds to a second group of three receive ports.

17. The method of claim 15, wherein the first number is one and the second number is eight, and wherein the SRS resource grouping indicates at least one of: a first plurality of four SRS resources are grouped together and a second plurality of four SRS resources are grouped together, or a first SRS resource set that includes four SRS resources corresponds to a first group of four receive ports and a second SRS resource set that includes four other SRS resources corresponds to a second group of four receive ports.

18. The method of claim 15, wherein the first number is two and the second number is eight, and wherein the SRS resource grouping indicates at least one of: a first plurality of two SRS resources are grouped together and a second plurality of two SRS resources are grouped together, or a first SRS resource set that includes two SRS resources corresponds to a first group of four receive ports and a second SRS resource set that includes two other SRS resources corresponds to a second group of four receive ports.

19. The method of claim 15, wherein the first number is four and the second number is eight, and wherein the SRS resource grouping indicates at least one of: a first group of one SRS resource and a second group of SRS resource, or a first SRS resource set that includes one SRS corresponds to a first group of four receive ports and a second SRS resource set that includes another SRS resource corresponds to a second group of four receive ports.

20. The method of claim 15, wherein the first number is eight and the second number is eight, and wherein the SRS resource grouping indicates that a first plurality of four SRS ports associated with an SRS resource are grouped together and a second plurality of four SRS ports also associated with the SRS resource are grouped together.
